(19) United States
(12) Patent Application Publication
(10) Pub. No.: US 2013/0017384 A1
(43) Pub. Date: Jan. 17, 2013

(54) POLYURETHANE COMPOSITE MATERIAL AND METHOD FOR FORMING THE SAME

(71) Applicants: CHI-WEN LEE, TAIPEI (TW); TIEN-CHAI KUO, TAIPEI (TW)

(72) Inventors: CHI-WEN LEE, TAIPEI (TW); TIEN-CHAI KUO, TAIPEI (TW)

(21) Appl. No.: 13/462,558

(22) Filed: May 2, 2012

(30) Foreign Application Priority Data
Jul. 15, 2011 (TW) 100125045

(51) Int. Cl. B32B 7/02; B32B 27/06; B32B 3/26; B29C 45/14; B32B 5/16

(52) U.S. Cl. 428/217; 264/46.4

(57) ABSTRACT

A polyurethane composite material and a method for forming the same are disclosed. The method for forming the polyurethane composite material includes forming a leather layer having a polyester resin; and forming a foam encapsulating at least an implant in the mold. The polyurethane composite material has the leather layer, which is formed on a surface of the foam, and the foam is formed by polyurethane, and the hardness of the leather layer is 3 H to 5 H and more than the hardness of the foam. The polyurethane composite material of the present invention has a leather layer, so as to avoid pores or cracks on a surface of final products, reduce additional processing, improve production rate, and enhance strength of final products.

### BACKGROUND OF THE INVENTION

1. Field of the Invention

The present invention relates to polyurethane composite materials and methods for forming the same, and more particularly, to a polyurethane composite material without surface pores and with high strength and a method for forming the same.

2. Description of Related Art

A polyurethane (PU) is a polymer composed of diisocyannates and hydroxyl group compounds. The PU may be used in wide applications such as coatings, car accessories, artificial leathers and furniture, and also used in sound insulation plates and frozen products due to having great effects on sound insulation and thermal insulation. The PU foam is generally used in seat cushions, roof panels, wall spacers and door plates.

The PVC leather is applied in a mold and tightly attached to the mold via a vacuum pump, and then the PU foam is injected into the mold to form a seat cushion. The PU seat cushion is elastic and comfortable, but fails to have great hardness and strength.

The strength of the PU foam needs to be enhanced by adding reinforcing material for forming door plates. FIG. 4 shows the conventional PU composite material and the method for forming the conventional PU composite material. The reinforcing material 45 such as wood blocks is placed in a mold 40, and the foamed PU 47 is then injected into the mold 40, so as to form the PU composite material. In order to improve strength of products, the hard PU with high foam density is used; however, there are pores 48 formed on the surface of the PU composite material. The surface of the PU composite material needs to be modified, such that additional processing is needed, the production rate is decreased and the quality of products is not satisfactory.

Hence, there is an urgent need to develop a PU composite material and a method for forming the PU composite material, so as to avoid pores formed on the surface of the PU composite material, reduce subsequent processing, maintain strength of products and improve production rate.

### SUMMARY OF THE INVENTION

The present invention provides a method for forming a polyurethane composite material. The method includes the steps of forming a leather layer in a mold; forming a foam for encapsulating at least an implant in the mold with the leather layer formed therein, so as to form a polyurethane composite material having the leather layer and the foam with the at least an implant encapsulated therein, wherein the leather layer is higher in hardness than the foam; and separating the polyurethane composite material from the mold.

In order to avoid pores or defects formed on a surface of the polyurethane composite material, the leather layer is formed in the inner surface of the mold. In the method of the present invention, the leather layer includes a polyester resin, a toughening agent, a stress dispersing agent and a coupling agent, wherein the hardness of the leather layer is 3 H to 5 H.

In the method of the present invention, an amount of the toughening agent is 10 to 90 wt % of the polyester resin, an amount of the stress dispersing agent is 10 to 25 wt % of the polyester resin, and an amount of the coupling agent is 0.3 to 0.5 wt % of the polyester.

In the method of the present invention, the foam with the at least an implant encapsulated therein is formed by disposing the at least an implant in the mold having the leather layer, and filling polyurethane reactants into the mold so as to form a polyurethane foam. Alternatively, the foam with at least an implant encapsulated therein is formed by mixing the implant and polyurethane reactants, and forming a polyurethane foam in the mold. If the foam is formed by mixing the implant and the reactants, the implant is a powder or a plurality of particles.

Further, in the method of the present invention, the leather having a thickness of 0.05 to 10 mm is formed by spraying, coating or injection. The stress dispersing agent such as a sheet-shaped powder facilitates the spray or coating to form the leather layer, and avoid formation of pores or defects. For example, the stress dispersing agent is a glass flake, graphite or a mica sheet.

According to the above method, the present invention provides a polyurethane composite material, including at least an implant; a foam encapsulating the implant, wherein the foam is a foamed polyurethane; and a leather layer formed on at least a surface of the foam, wherein the hardness of the leather layer is 3 H to 5 H, and the hardness of the leather layer is higher than hardness of the foam. The hardness of the foam may be shore A70 to 95.

The leather layer includes a polyester resin, a toughening agent, a stress dispersing agent and a coupling agent. Preferably, the polyester resin has no nitrogen atoms, but has C(═O)OR, wherein R is an alkyl group, for example. The polyester resin may be prepared from an acidic monomer having at least two functional groups and an alcohol monomer. The polyester resin may be commercially purchased.

In the polyurethane composite material, the implant is a block, a sheet, a powder or a plurality of particles. Since the polyurethane composite material of the present invention has the leather layer and the foam, the density of the polyurethane foam may be reduced to 0.05 to 0.9 g/cm³.

In the polyurethane composite material of the present invention, the leather layer may be formed only on a lateral surface of the foam, two opposing surfaces of the foam, or all surfaces of the foam.

Further, the leather layer may include a dye and hydroquinone (HQ-10%), and an amount of the dye is 15 to 25 wt % of the polyester resin.

In the present invention, a leather layer with higher hardness is formed in a mold, such that the polyurethane composite material has the leather layer. Such polyurethane composite material is easily operated, and has wood-like texture. Further, the foam has lower density without reducing final strength of final products, and the implant may even increase the strength of the polyurethane composite material. In addition, the leather layer formed in the mold can avoid pores or cracks from being generated on a surface of products, and therefore no additional modifying procedures are needed.

### BRIEF DESCRIPTION OF THE DRAWINGS

FIGS. 1A to 1C are schematic views showing the polyurethane composite material and the method for forming the polyurethane composite material according to the present invention, wherein FIG. 1B′ is a three-dimensional view of FIG. 1B;

FIG. 2 is a schematic view showing the polyurethane composite material according to the second embodiment of the present invention;

FIG. 3 is a schematic view showing the polyurethane composite material according to the third embodiment of the present invention; and

FIG. 4 is a schematic view showing the conventional polyurethane composite material and the method for forming the same.

### DETAILED DESCRIPTION OF THE PREFERRED EMBODIMENTS

The detailed description of the present invention is illustrated by the following specific examples. Persons skilled in the art can conceive the other advantages and effects of the present invention based on the disclosure contained in the specification of the present invention.

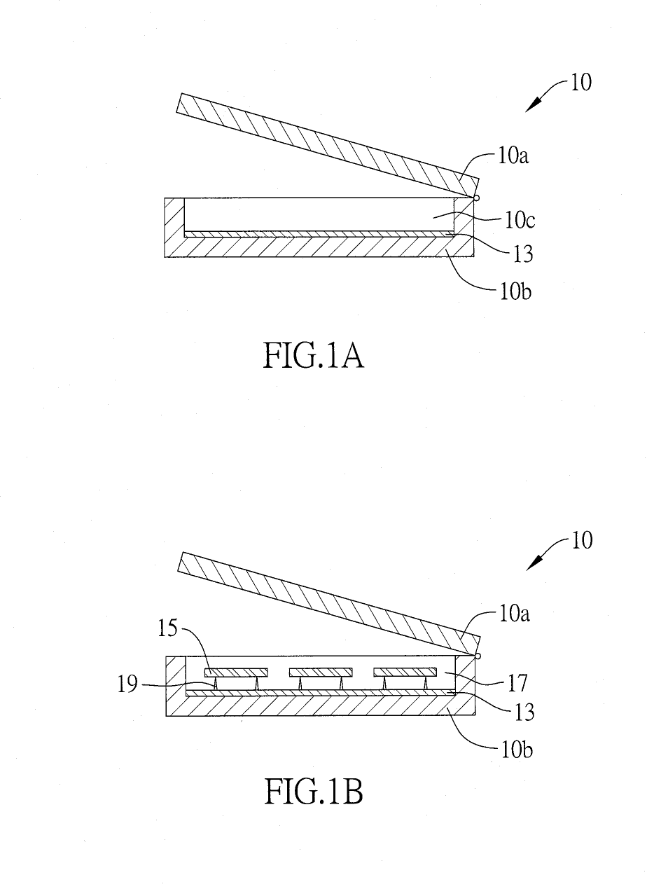

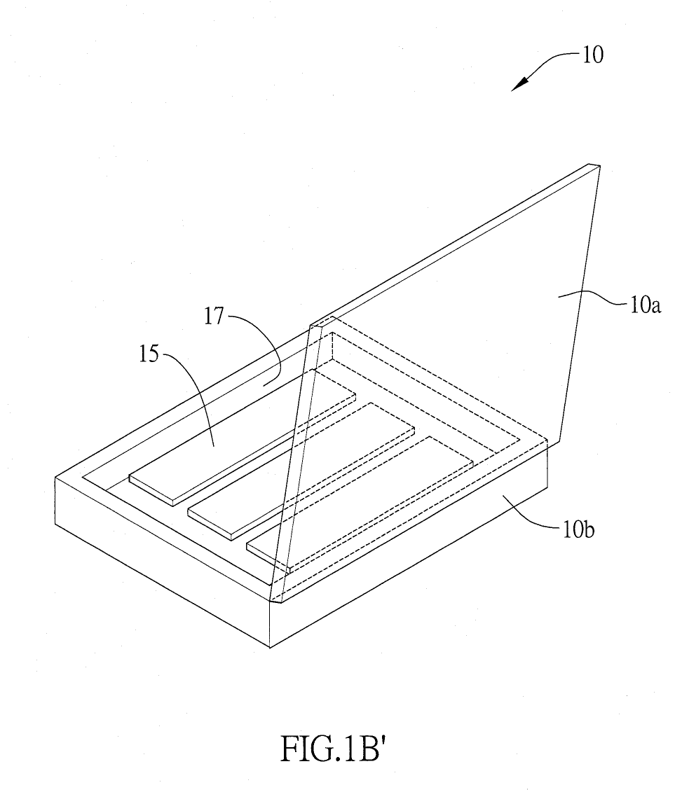

FIG. 1A to FIG. 1C show the method for forming the polyurethane composite material of the present invention.

As shown in FIG. 1A, a mold 10 includes an upper mold 10a ad a lower mold 10b, and a leather layer 13 is formed in a mold cavity 13 of the mold 10 by spraying, coating or injection. Preferably, the leather layer 13 is formed in a mold cavity 13 of the mold 10 by coating. The leather layer 13 is optionally formed on at least a surface of the mold cavity 10c in the mold 10. Preferably, the leather layer 13 is formed on two opposing inner surfaces of the mold 10. More preferably, the leather layer 13 is formed on the entire inner surface of the mold 10. The above-mentioned at least a surface is directed to the one of the final product that is subject to the most frequent contact or stress application. The surface of the final product formed with the leather layer 13 can have better appearance and mechanical strength. Further, the leather layer includes a polyester resin, a toughening agent, a stress dispersing agent and a coupling agent, and the hardness of the leather layer is 3 H to 5 H. Certainly, the leather layer may include a dye and hydroquinone. The thickness of the leather layer is 0.05 to 10 mm.

In the present invention, the toughening agent may be, but not limited to, an acrylic nitrile rubber, a butadiene rubber, an acrylic-butadiene rubber, a phenylethene-butadiene-phenylethene copolymer, a rubber with a carboxylic terminal, a rubber with an amino terminal, a rubber with an epoxy group end, a silicone rubber, a polyacrylic rubber, or another polyester resin. The stress dispersing agent may be a glass flake, graphite or a mica sheet.

The coupling agent may be, but not limited to, a silane coupling agent such as vinyltrichloro silane, ethenyl triethoxysilane, ethenyl trimethoxysilane, γ-methacryloxypropyl trimethoxysilane, β-(3,4-epoxycyclohexyl)ethyltrimethoxysilane, γ-glycidoxypropyldimethylethoxysilane, N-β-(aminoethyl)γ-aminopropylmethylmethoxysilane, γ-aminopropyltriethoxysilane, N-phenyl-γ-aminopropyltrimethoxysilane, γ-mercaptopropyltrimethoxysilane, γ-chloropropyltrimethoxysilane; a titanate coupling agent; an aluminum coupling agent; a zircoaluminate coupling agent; a silane coupling agent or a fluorine coupling agent. The above coupling agents may be used singly or in combination.

The dye may be a dye or a pigment, which may be, but not limited to, titanium dioxide, zinc oxide, carbon black, cadmium yellow, chrome yellow, titanium yellow, benzidine yellow G, benzidine yellow 10G or cadmium red.

As shown in FIG. 1B and FIG. 1B′, a foam 17 is formed in the mold cavity 10c having the leather layer 13 for encapsulating the implant 15, wherein the foam 17 is a foamed polyurethane. The hardness of the foam 17 is shore A 70 to 95, and the hardness of the leather layer 13 is higher than the hardness of the foam 17. Preferably, the hardness of the foam 17 is shore A 80 to 95, and more preferably 85 to 95. In this embodiment, in the mold 10 having the leather layer 13, the implant 15 is disposed; reactants for preparing a polyurethane are filled in the mold 10; a foamed polyurethane is formed in the mold 10; and the upper mold 10a and the lower mold 10b are sealed, so as to form the polyurethane composite material of the present invention. In this embodiment, the mold has a support 19 for carrying the implant 15 thereon, such that the implant 15 is encapsulated by the foam 17. The implant with bigger volume may be a block or a sheet, wherein the block and the sheet may be in a solid or hollow form. For example, the implant may be a frame type or a framework type. There is no limitation to the material of the implant in the present invention. The implant may be a wood, a medium density fiberboard (MDF), a plastic plate, a plastic foam plate, a metal, a glass fiber or an asbestos board. While pursuing light weight of products, glass fibers may be used. A metal implant is used for burglarproof.

The foam of present invention may be a hard foamed PU. The hard foamed PU may be formed by, but not limited to, a polyether such as poly propylene glycol or a polyester reacting with a polymeric isocyanate in the presence of a blowing agent. Certainly, other hard foamed PU may be used.

FIG. 1C shows another method for forming a foam. If the implant is a powder or a plurality of particles, the implant 15 is first mixed with the reactants, i.e. the polyether or the polyester, and then mixed with the polymeric isocyanate. The mixture is injected into the mold 10, which has the leather layer 10, to form the PU foam 17.

In the above-mentioned polyurethane composite material, the density of the foam may be decreased to 0.05 to 0.9 g/cm³. Preferably, the density of the foam is 0.08 to 0.5 g/cm³. More preferably, the density of the foam is 0.1 to 0.3 g/cm³. The lower density facilitates the filling of the foamed PU in the mold, and facilitates to reduce cost.

Finally, the foam coated with the leather layer is released from the mold, such that the polyurethane composite material of the present invention is obtained.

According to the previous method, the present invention further provides a polyurethane composite material. The polyurethane composite material includes an implant 15; a foam 17 encapsulating the implant 15, wherein the foam 17 is a hard foamed PU; and a leather layer 13 formed on at least a surface of the foam 17. The leather layer 13 includes a polyester resin, a toughening agent, a stress dispersing agent and a coupling agent, wherein an amount of the toughening agent is 10 to 90 wt % of the polyester resin, an amount of the stress dispersing agent is 10 to 25 wt % of the polyester resin, an amount of the coupling agent is 0.3 to 0.5 wt % of the polyester, hardness of the leather layer is 3 H to 5 H, and the hardness of the leather layer 13 is more than the hardness of the foam 17.

In the polyurethane composite material of the present invention, the implant may be a block, a sheet a powder or a plurality of particles, wherein the block and the sheet may be in a solid or hollow form. For example, the implant may be a frame type or a framework type. There is no limitation to the material of the implant in the present invention. The implant may be a wood, a medium density fiberboard, a plastic plate, a plastic foam plate, a metal, a glass fiber or an asbestos board. While pursuing light weight of products, glass fibers may be used. A metal implant is used for burglarproof.

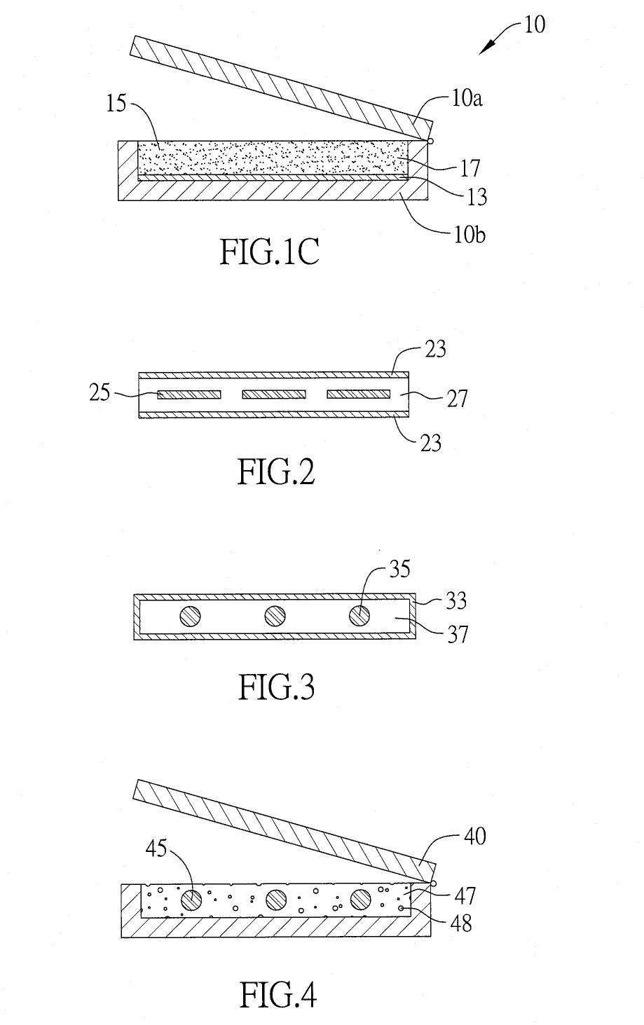

FIG. 2 is a schematic view showing the second embodiment of the present invention. This embodiment is similar to the previous embodiment except that the leather layer is formed on two opposing inner surfaces of the mold in this embodiment. As shown in FIG. 2, the implant 25 is disposed as that in the previous embodiment, and the leather layer 23 is formed on two opposing surfaces of the foam 27.

FIG. 3 is a schematic view showing the third embodiment of the present invention. This embodiment is similar to the previous embodiments except that the leather layer is formed on all inner surfaces of the mold in this embodiment. As shown in FIG. 3, the implant 35 is disposed as that in the previous embodiments and the leather layer 33 is formed on all surfaces of the foam 37.

The polyurethane composite material may be used in various fields such as building materials, furniture, decorations, tools, and etc. The building materials may be a door plate, a wall spacer, a decoration, a sound insulation plate, an artificial wood, and etc. The furniture may be a desk, a chair, a bed frame, a bed plate, and the like.

Tests

Test method: ASTM (American Society for Testing and Materials (ASTM) D

An iron sheet was coated with phosphide priming paint, and dried. The leather layer of the present invention was formed on the iron sheet (Example) by brush coating, and dried. Then, 10 cold-hot cycle tests were performed. Comparative Example was performed in the same manner. The results of attachment force test were shown in Table 1.

In addition, the methods for measuring physical properties are illustrated as follows.

Gel time: according to hot-plate tests, the test sample was carried on the hot plate (175° C.), and the time from the test sample being melting to the test sample being hardened was measured. The measured time was the gel time.

Hardness test (pencil scratch hardness tester, Mitsubishi): the test sample was tested by the pencil scratch hardness tester immediately after the test sample was formed.

Resin: polymer of isophthalic acid, ethylene glycol and propylene glycol (K530, QUALIPOLY CHEMICAL CORP)

Toughening agent: polymer of phthalate and diethylene glycol (8528, QUALIPOLY CHEMICAL CORP)

Glass flake: medium-alkali glass (C150, GlassFlakes Co., Ltd)

Coupling agent: silane coupling agent (KH-570, GlassFlakes Co., Ltd)

TABLE 1

| Formulation of | | | | Comparative |
|---|---|---|---|---|
| leather layer | Example 1 | Example 2 | Example 3 | Example |
| resin | 64.3 | 69.3 | 73.3 | 90.3 |
| Toughening agent | 25.7 | 48.5 | 65.9 | 81.0 |
| Glass flake | 13 | 13 | 13 | — |
| Coupling agent | 0.26 | 0.26 | 0.26 | 0.26 |
| methyl ethyl | 1.2 | 1.2 | 1.2 | 1.2 |
| ketone peroxide | | | | |
| (MEKPO) | | | | |
| Co | 0.6 | 0.6 | 0.6 | 0.6 |
| Styrene monomer | 15 | 15 | 15 | 15 |
| (SM) | | | | |
| Attachment force | 5B | 4B | 4B | 3B |
| Gel time | 40 min | 40 min | 40 min | 30 min |
| Hardness | 3H | 4H | 5H | 5H |
| Appearance after | No cracks | No cracks | No cracks | cracks |
| cold-hot cycles | | | | |

In the present invention, since a leather layer with harder texture is formed in a mold, the leather layer has wood-like texture, and the subsequent foam may have lower density. The strength of final products would not be reduced, and no adhesive needs to be used for the attachment between the leather layer and the foam. Further, the implant is disposed for maintaining or further improving the strength of the polyurethane composite material. In addition, the leather layer is formed in the mold so as to avoid pores or cracks from being formed on surfaces of final products, and thus no additional processing for modifying the pores and cracks is needed.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. A method for forming a polyurethane composite material, comprising the steps of:
forming a leather layer in a mold, wherein the leather layer comprises a polyester resin, a toughening agent, a stress dispersing agent and a coupling agent, an amount of the toughening agent is 10 to 90 wt % of the polyester resin, an amount of the stress dispersing agent is 10 to 25 wt % of the polyester resin, an amount of the coupling agent is 0.3 to 0.5 wt % of the polyester, and hardness of the leather layer is 3 H to 5 H;
forming in the mold having the leather layer a foam for encapsulating at least an implant predisposed in the mold, so as to form the polyurethane composite material having the leather layer and the foam with the at least an implant encapsulated therein, wherein the leather layer is higher in hardness than the foam; and
separating the polyurethane composite material from the mold.

2. The method of claim 1, wherein the foam with the at least an implant encapsulated therein is formed by predisposing the implant in the mold having the leather layer, and filling into the mold polyurethane reactants to form the polyurethane foam.

3. The method of claim 1, wherein the foam with the at least an implant encapsulated therein is formed by mixing the at least an implant and polyurethane reactants, and then introducing the mixed at least an implant and polyurethane reactants into the mold having the leather layer.

4. The method of claim 3, wherein the implant is a powder or a plurality of particles.

5. The method of claim 1, wherein density of the foam ranges from 0.05 to 0.9 g/cm³.

6. The method of claim 1, wherein hardness of the foam is shore A 70 to 95.

7. The method of claim 1, wherein the polyester resin has no nitrogen atoms.

8. The method of claim 1, wherein the stress dispersing agent is a flake powder.

9. The method of claim 8, wherein the stress dispersing agent is a glass flake, graphite or a mica sheet.

10. The method of claim 1, wherein the leather layer further comprises a dye and hydroquinone.

11. The method of claim 1, wherein a thickness of the leather layer is 0.05 to 10 mm.

12. The method of claim 1, wherein the implant is a block, a sheet, a powder or a plurality of particles.

13. The method of claim 1, wherein the leather layer is formed by spraying, coating or injection.

14. A polyurethane composite material, comprising:
at least an implant;
a foam for the at least an implant to be encapsulated therein, wherein the foam is a polyurethane foam; and
a leather layer formed on at least a surface of the foam, and comprising a polyester resin, a toughening agent, a stress dispersing agent and a coupling agent, wherein hardness of the leather layer is 3 H to 5 H, and the leather layer is higher in hardness than the foam.

15. The polyurethane composite material of claim 14, wherein an amount of the toughening agent is 10 to 90 wt % of the polyester resin, an amount of the stress dispersing agent is 10 to 25 wt % of the polyester resin, and an amount of the coupling agent is 0.3 to 0.5 wt % of the polyester.

16. The polyurethane composite material of claim 14, wherein the implant is a block, a sheet, a powder or a plurality of particles.

17. The polyurethane composite material of claim 14, wherein density of the foam is 0.05 to 0.9 g/cm³.

18. The polyurethane composite material of claim 14, wherein the hardness of the foam is shore A 70 to 95.

19. The polyurethane composite material of claim 14, wherein the polyester resin has no nitrogen atoms.

20. The polyurethane composite material of claim 14, wherein the stress dispersing agent is a sheet-shaped powder.

21. The polyurethane composite material of claim 20, wherein the stress dispersing agent is a glass flake, graphite or a mica sheet.

22. The polyurethane composite material of claim 14, wherein the leather layer further comprises a dye and hydroquinone.

23. The polyurethane composite material of claim 14, wherein a thickness of the leather layer is 0.05 to 10 mm.

24. The polyurethane composite material of claim 14, wherein the leather layer is formed on two opposing surfaces of the foam.

25. The polyurethane composite material of claim 14, wherein all surfaces of the foam are coated by the leather layer.
